(19) United States
(12) Patent Application Publication
(10) Pub. No.: US 2008/0010516 A1
(43) Pub. Date: Jan. 10, 2008

(54) Method and apparatus for indicating the actual progress of a booting procedure

(75) Inventor: Ying-Chih Lu, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 11/452,332

(22) Filed: Jun. 14, 2006

(51) Int. Cl. G06F 11/00

(52) U.S. Cl. 714/15

(57) ABSTRACT

A method for indicating the actual progress of a booting procedure obtains a time value required for completing a booting of a computer device and indicates a plurality of progress units sequentially filled into a progress indicating unit within the time value. An apparatus adopting this method includes a screen for displaying a progress indicating unit having a plurality of progress units; a timer for issuing an interrupt signal according to a cycle, and any interrupt signal can issue a display instruction to accumulate at least one progress unit in the progress indicating unit; a memory for storing a BIOS initialization procedure and a time value; a processor for reading the time value and the resolution of the screen to compute a display frequency for sequentially displaying the progress units on the progress indicating unit and sequentially displaying the progress units on the screen according to the display frequency.

### FIELD OF THE INVENTION

The present invention relates to a method and an apparatus for indicating the actual progress of a booting procedure, and more particularly to a method and an apparatus for indicating the actual progress of a booting procedure by obtaining a time value required for completing the booting of a computer and showing a plurality of progress units on a progress indicating unit within the time value.

### BACKGROUND OF THE INVENTION

As our life enters into an era of blooming electronic industries, various high-tech products derived from computers are developed rapidly to give tremendous breakthroughs to the development of science and technology. However, as various electronic technologies are developed and advanced unceasingly, the initialization executed for the booting of various electronic devices becomes very powerful, and the program codes become increasingly larger. After a computer device is turned on, a basic input output system (BIOS program) initializes the computer device. If the power-on button of the computer device is pressed, the BIOS program will start detecting each module (such as a hard disk) of the computer device and its system and initializing the setup and testing of each module to assure a normal operation of the system. If any abnormal module is detected, the BIOS program will stop operating and indicate an error of the respective module by displaying related information.

The BIOS program includes a power on self test (POST) program and a system startup program, and these programs are used primarily for communicating with a motherboard and other computer hardware equipments, and the BIOS program is a memory resident program installed in the computer device for providing a low-level direct hardware control, wherein the function of power on self test (POST) is to test all of the internal equipments and components such as a central processing unit (CPU), a memory, a read only memory (ROM), a motherboard, a CMOS memory, a serial input/output controller, a floppy disk, a hard disk and a keyboard of the computer device when the computer device is turned on.

When the BIOS program initializes the computer device, the progress of the initialization process will be displayed to indicate the time required for executing such program. A progress bar is usually displayed on a screen, and a hollow band area appears on the progress bar during the initialization, and the band area will be filled progressively based on the progress. After the band area is filled up with a plurality of progress units, it shows that the execution of the program is completed.

The present method for indicating a progress bar generally and sequentially builds a plurality of check points in the program codes in advance, so that if the computer device executes the program code to read a check points, the program code will be interrupted to issue an instruction, so as to fill one or more progress units into the hollow area of the remaining progress bar, and then continue executing the program codes repeatedly until the banding area is completely filled up. However, the time for reading the program codes between any two check points varies, and if any other function of the motherboard is enabled or a new hardware (such as a display card) is added during that time period and the computer device executes the same basic module in different hardware equipments, the time consumed will be different and the filled area of the progress shown in the progress bar will be uneven. Thus, such arrangement cannot indicate the actual progress of the executed program. For example, if a program is executed halfway but the filled area of the progress shown in the progress bar only indicates 40% of the program is completed, users cannot know the actual time required for executing the whole program from the progress indicating unit, and thus users cannot know how much more time it will take to complete the execution of the whole program.

In view of the forgoing inconvenience, finding a method for indicating the actual progress of a booting procedure that evenly indicates the actual progress of the executed program and shows the time required for the initialization process is an important issue that demands immediate attention.

### SUMMARY OF THE INVENTION

In view of the shortcomings of the prior art progress indicating unit that cannot indicate the progress of the actual execution of the foregoing program, the inventor of the present invention based on years of experience in the related industry to conduct extensive researches and experiments, and finally invented a method and an apparatus for indicating the actual progress of a booting procedure in accordance with the present invention.

The primary objective of the present invention is to provide a method for indicating the actual progress of a booting procedure that obtains a first time value required for completing a booting procedure when a computer device is booted, and then fills a plurality of progress units sequentially in a progress indicating unit within the first time value for indicating the progress.

Another objective of the present invention is to determine a display frequency of each progress unit by the computer device according to the first time value and the resolution of the screen during a booting procedure which involves a BIOS initialization procedure, and then adjust the quantity of progress units according to the display frequency, and sequentially show each progress unit on a progress indicating unit according to the quantity of the progress units, so as to indicate the progress of the BIOS initialization procedure. When the progress indicating unit is completely filled with the progress units, it shows that the execution of the BIOS initialization procedure is completed.

A further objective of the present invention is to provide an apparatus for indicating the actual progress of a booting procedure, wherein a computer device includes a screen, a timer, a memory and a processor. The screen is provided for displaying a progress indicating unit having a plurality of progress units; the timer issues an interrupt signal periodically, and any interrupt signal can issue a display instruction to accumulate at least one progress unit in the progress indicating unit; the memory stores a BIOS initialization procedure and a first time value; and the processor reads the first time value and the resolution of the screen to compute a display frequency for sequentially displaying the progress units on the progress indicating unit and sequentially displaying the progress units on the screen.

The above and other objects, features and advantages of the present invention will become apparent from the following detailed description taken with the accompanying drawings.

### BRIEF DESCRIPTION OF THE DRAWINGS

FIG. 1 is a schematic block diagram of the present invention;

FIG. 2 is a schematic view of a progress indicating unit according to a preferred embodiment of the present invention;

FIG. 3 is a flow chart of a preferred embodiment of the present invention;

FIG. 4 is a flow chart of sequentially filling a hollow frame according to a preferred embodiment of the present invention;

FIG. 5 is a flow chart of conducting an operation to a hollow frame based on the completion of a BIOS initialization procedure according to a preferred embodiment of the present invention; and

FIG. 6 is a flow chart of generating a first time value according to a preferred embodiment of the present invention.

### DETAILED DESCRIPTION OF THE PREFERRED EMBODIMENTS

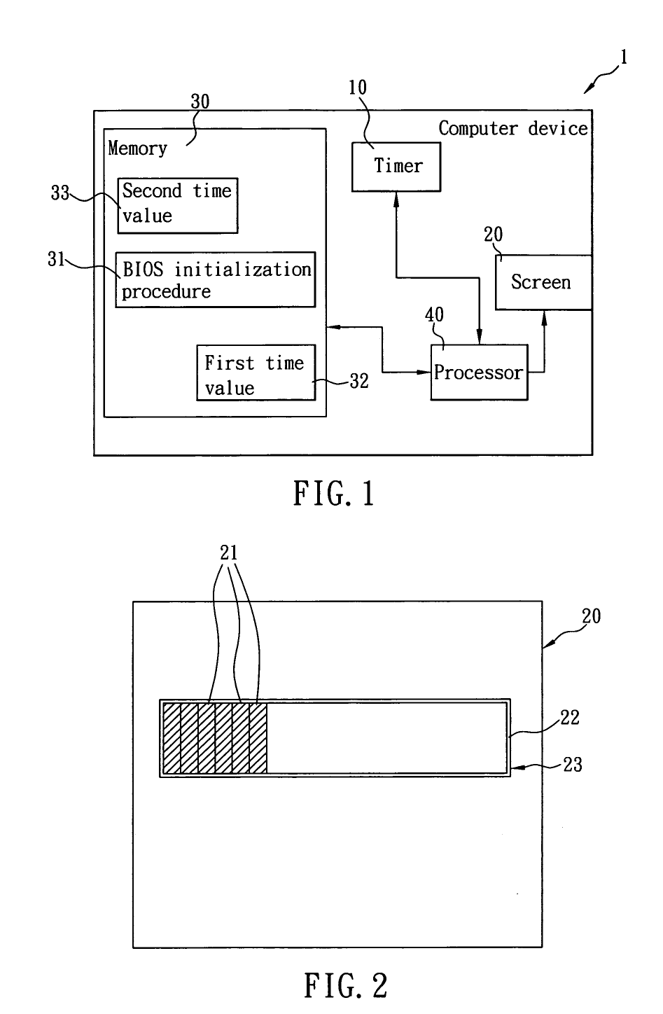

Referring to FIGS. 1 and 2 for the method for indicating the actual progress of a booting procedure according to the present invention, a computer device 1 obtains a first time value 32 required for a booting procedure when the computer device 1 is booted and sequentially shows a plurality of progress units 21 on a progress indicating unit 23 within the first time value 32, wherein the booting procedure is a BIOS initialization procedure 31. The computer device 1 determines a display frequency for displaying each progress unit 21 according to the first time value 32 and the resolution of a screen 20 of the computer device 1 and adjusts the quantity of progress units 21 according to the display frequency, and sequentially shows each progress unit 21 on the progress indicating unit 23 according to the quantity of progress units 21 to indicate the progress of the BIOS initialization procedure 31. If the progress indicating unit 23 is completely filled with the progress units, it shows that the execution of the BIOS initialization procedure 31 is completed.

In FIGS. 1 and 2, the computer device 1 includes a timer 10, a memory 30 (such as a complementary metal oxide semiconductor (CMOS) or a non-volatile memory (NVRAM)), a flash memory (flash ROM) and a processor 40, wherein the timer 10 issues an interrupt signal (such as IRQ0, Interrupt Request Number 0 which usually issues 18.21590 interrupt signals per second; in other words, an interrupt signal is issued periodically once for every 1/18.21590 second) according to a cycle. The computer device 1 uses an interrupt signal to issue a display instruction while carrying out the BIOS initialization procedure 31, so that a progress unit 21 is accumulated in the progress indicating unit 23.

The BIOS initialization procedure 31 is stored in the memory 30, and after the processor 40 reads the BIOS initialization procedure 31 from the memory 30 and executes the BIOS initialization procedure 31 for each time, the processor 40 will record a first time value 32 consumed for this particular time back into the memory 30, such that if the computer device 1 adds a new hardware (such as a display card), the processor 40 will execute the BIOS initialization procedure 31 to obtain a different time value which is recorded in the first time value 32 in the memory 30. When the BIOS initialization procedure 31 is executed for the next time, the updated first time value 32 can be used to indicate the actual progress of the BIOS initialization procedure 31. However, the present invention cannot obtain the first time value 32 to continue the later steps, if the first time value 32 is damaged or the memory 30 is damaged, and thus the first time value 32 cannot be read. The computer device 1 reads the default second time value 33 stored in the memory 30 to substitute the first time value 32 to find the reference data and continue the later steps, whenever the first time value 32 cannot be read.

If there is a change of hardware in the computer device 1 and the BIOS initialization procedure 31 is executed for the first time, the progress units 21 displayed on the progress indicating unit 23 cannot truly indicate the process of the initialization procedure, but the chance for users to change the hardware or the parameters of a computer device 1 is not very high, and thus the parameters required for executing the BIOS initialization procedure 31 is very close to the first time value 32 provided that the hardware and parameter of the computer device 1 have not been changed.

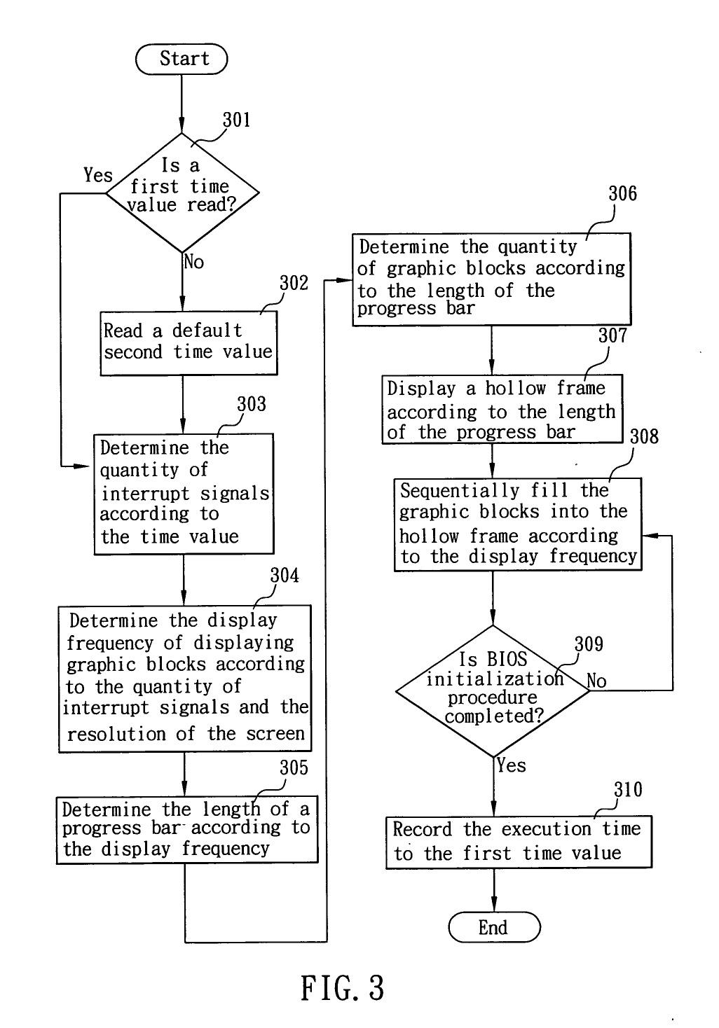

Referring to FIGS. 1 and 2 for a preferred embodiment of the present invention, the progress indicating unit 23 is a progress bar displayed on the screen 20, and the progress units 21 are filled into a graphic block on the progress bar, and the graphic block could be a block (such as ▪), a symbol (such as > or %) or a figure, and the progress bar sequentially shows the graphic blocks on the progress bar according to the progress of the initialization procedure of the BIOS program. After the processor 40 starts the BIOS initialization procedure 31, the processor 40 will carry out the following procedure as shown in FIG. 3:

(Step 301) Search for the memory 30 and determine whether or not the first time value 32 is read; if yes, then carry out Step 303, or else carry out Step 302;

(Step 302) Read the default second time value 33;

(Step 303) Determine the quantity of interrupt signals periodically issued by the timer 10 according to the read time value;

(Step 304) Determine a display frequency for displaying the graphic blocks according to the quantity of interrupt signals and the resolution of the screen 20;

(Step 305) Determine the length and size of the progress bar according to the display frequency;

(Step 306) Determine the quantity of graphic blocks according to the length and size of the progress bar;

(Step 307) Display a hollow frame 22 having a length and a size equal to those of the progress bar on the screen according to the length and size of the progress bar;

(Step 308) Sequentially fill at least one graphic block in the hollow frame 22 according to the display frequency;

(Step 309) Determine whether or not the BIOS initialization procedure 31 is end; if yes, then carry out Step 310, or else carry out Step 308;

(Step 310) Save the time required for executing the BIOS initialization procedure 31 in the first time value 32 in the memory 30.

In the foregoing embodiment, a first time value 32 stored in the memory 30 is equal to 60 seconds, and thus the timer 10 can issue (60*18.2 equal to) 1092 interrupt signals when the BIOS initialization procedure 31 is executed, and the resolution of the computer device 1 is 640×480×8 bpp (bit per pixel). Therefore the horizontal length shown on the screen 20 includes 640 horizontal pixels, and the ratio of displaying the progress bar on the screen 20 is 9/10. Therefore, the horizontal length of the progress bar shown on the screen 20 includes (640*9/10 equal to) 576 horizontal pixels. If one vertical pixels stands for a graphic block, then the hollow frame 22 can contain 576 graphic blocks and the processor 40 can compute the interrupt signals once for every ( 1092/576 equal to) 1.8958 times to fill a graphic block to the hollow frame 22. Since the number of interrupt signals is not an integer and a more accurate time cannot be obtained, therefore the number of interrupt signals is rounded to the nearest integer (for example, 1.8958 is rounded up to 2), and the display frequency is 2 (In other words, a display function for filling a graphic block is issued once for every two interrupt signals).

The display frequency issues a display instruction for filling a graphic block once for every two interrupt signals until the last time of issuing the display instruction for filling a graphic block to completely fill up the progress bar. In 1092 times of issuing interrupt signals, any two times of interrupt signals fills a graphic block, and thus there is a total of ( 1092/2 equal to) 546 graphic blocks, and the hollow frame 22 is filled up with 546 vertical pixels.

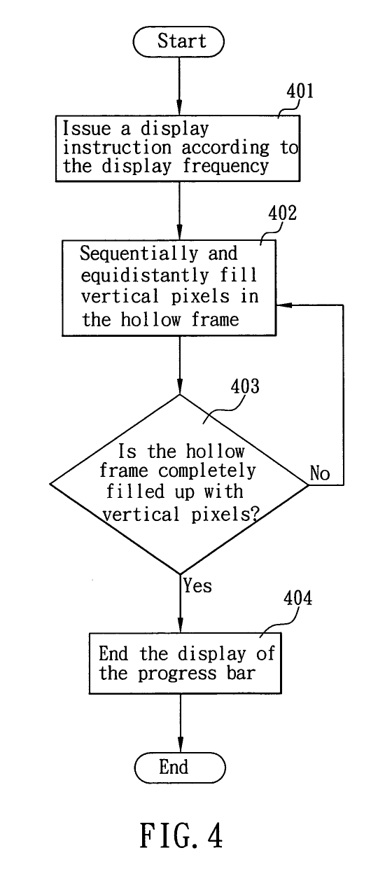

After the processor 40 determines the horizontal length of the progress bar, the processor 40 will display the hollow frame 22 on the screen 20 according to horizontal length and a vertical length (such as 10 pixels) of the progress bar as shown in FIG. 4, and the processor 40 will process the following procedure:

(Step 401) Issue a display instruction to the screen 20 according to the display frequency in the interrupt signals.

(Step 402) Sequentially and equidistantly fill at least one vertical pixel in the hollow frame 22 from an end to another end of the hollow frame 22.

(Step 403) Determine whether or not the hollow frame 22 is completely filled up with the vertical pixels; if yes, then carry out Step 404, or else carry out Step 402.

(Step 404) End the display of the progress bar.

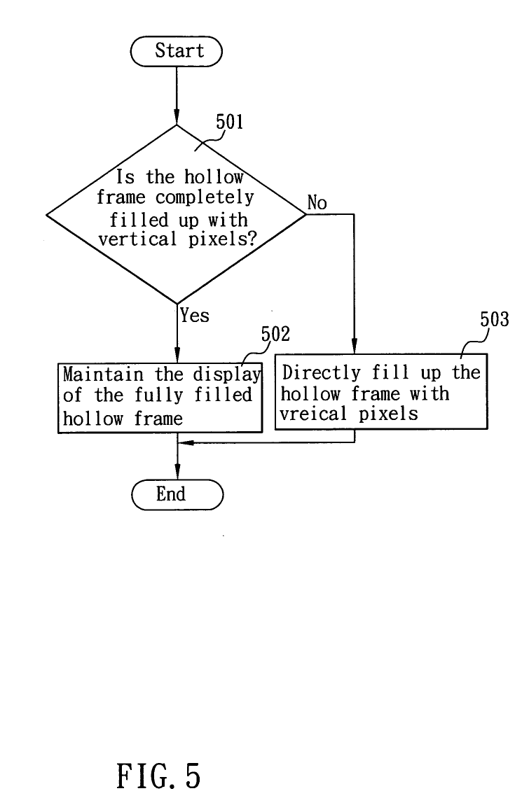

In FIGS. 1 and 2, the first time value 32 cannot effectively indicate the progress of the BIOS initialization procedure 31 due to a change of hardware after executing the invention for the first time. When the BIOS initialization procedure 31 comes close to an end as shown in FIG. 5, the processor 40 will carry out the following procedure:

(Step 501) Determine whether or not the hollow frame 22 is completely filled up with the vertical pixels; if yes, then carry out Step 502, or else carry out Step 503;

(Step 502) Maintain the display of the completely filled hollow frame 22, until the BIOS initialization procedure 31 ends.

(Step 503) Directly fill the vertical pixels into the hollow frame 22, until the hollow frame 22 is completely filled up with the vertical pixels.

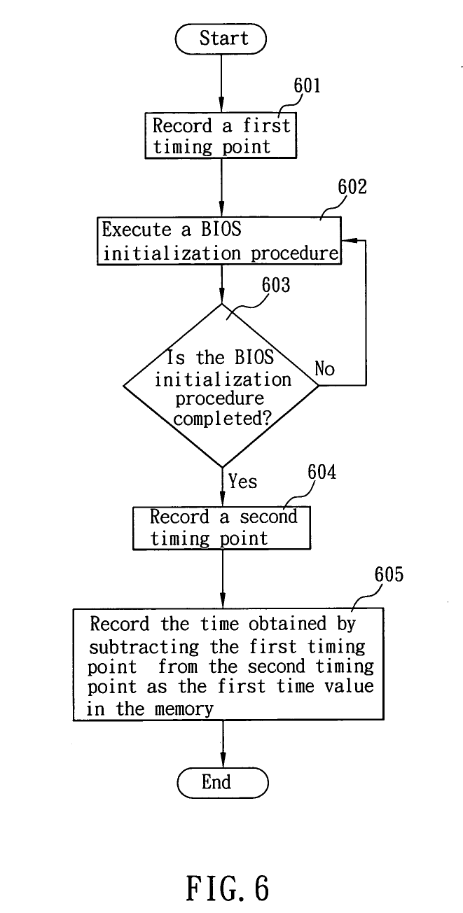

After the computer device 1 is turned on and the processor 40 starts the BIOS initialization procedure 31, the processor 40 will process the following procedure as shown in FIG. 6:

(Step 601) Record a first timing point.

(Step 602) Execute a BIOS initialization procedure 31.

(Step 603) Determine whether or not the BIOS initialization procedure 31 is completed; if yes, then carry out Step 604, or else carry out Step 602.

(Step 604) Record a second timing point.

(Step 605) Record the time obtained by subtracting the first timing point from the second timing point as the first time value 32 in the memory 30.

While the invention herein disclosed has been described by means of specific embodiments, numerous modifications and variations could be made thereto by those skilled in the art without departing from the scope and spirit of the invention set forth in the claims.

What is claimed is:

1. A method for indicating the actual progress of a booting procedure, comprising the steps of:
obtaining a first time value required for completing a booting of a computer device; and
indicating a plurality of progress units sequentially filled into a progress indicating unit within said first time value.

2. The method of claim 1, wherein said computer device starts a BIOS initialization procedure, when said computer boots, and said computer device carries out a procedure comprising the steps of:
determining a display frequency for displaying said progress units according to said first time value and the resolution of a screen of said computer device;
adjusting the quantity of said progress units according to said display frequency; and
sequentially showing said each progress unit on a progress indicating unit.

3. The method of claim 2, wherein said computer device includes a timer and a processor, and said progress indicating unit shows a progress bar on said screen, and said progress units are filled into a graphic block of said progress bar, such that after said processor starts said BIOS initialization procedure, said processor carries out a procedure comprising the steps of:
searching for a memory installed in said computer device and determining whether or not to read said first time value;
determining the quantity of interrupt signals issued periodically by said timer according to said first time value, if said first time value is read;
determining a display frequency for displaying said graphic blocks according to the quantity of said interrupt signals and the resolution of said screen;
determining the length and size of said progress bar according to said display frequency;
determining the quantity of said graphic blocks according to the length and size of said progress bar;
sequentially displaying at least one graphic block according to said display frequency;
determining whether or not said BIOS initialization procedure is end; and
recording the time required for executing said BIOS initialization procedure as said first time value, when said BIOS initialization procedure is end.

4. The method of claim 3, wherein said memory stores a second time value, such that if said processor cannot read said first time value, then said processor will read said second time value instead and then will continue the later steps.

5. The method of claim 3, wherein said processor determines the length and size of said progress bar and then carries out the procedure comprising the steps of:
displaying a hollow frame identical to said progress bar on said screen according to the length and size of said progress bar;
issuing a display instruction to said screen according to said interrupt signals in said display frequency;
sequentially and equidistantly filling at least one graphic block into said hollow frame from one end to another end of said hollow frame;
determining whether or not said hollow frame is completely filled up with said graphic blocks; and
ending the display of said progress bar, if said hollow frame is completely filled up with said graphic blocks.

6. The method of claim 5, wherein when the execution of said BIOS initialization procedure is closed to an end, said processor carries out a procedure comprising the steps of:
determining whether or not said hollow frame is completely filled up with said graphic blocks;
maintaining the display of the completely filled hollow frame until said BIOS initialization procedure ends, when said hollow frame is completely filled up with said graphic blocks.

7. The method of claim 6, wherein said processor fills said graphic blocks into said hollow frame until said hollow frame is completely filled up with said graphic blocks, if said hollow frame is determined to be not completely filled up with said graphic blocks.

8. The method of claim 7, wherein said each graphic block comprises at least one vertical pixel, such that after said processor displays said hollow frame on said screen, said processor carries out a procedure comprising the steps of:
issuing a display instruction to said screen according to said interrupt signals of said display frequency;
sequentially and equidistantly filling at least one vertical pixel into said hollow frame from one end to another end of said hollow frame;
determining whether or not said hollow frame is completely filled up with said vertical pixels; and
ending the display of said progress bar, if said hollow frame is completely filled up with said vertical pixels.

9. The method of claim 5, wherein when said computer device boots and said processor enables said BIOS initialization procedure, said computer device carries out a procedure comprising the steps of:
recording a first timing point;
determining whether or not said BIOS initialization procedure is end;
recording a second timing point, if said BIOS initialization procedure is end; and
subtracting said first timing point from said second timing point, and recording the result to said first time value.

10. An apparatus for indicating the actual progress of a booting procedure, installed in a computer device, comprising:
a screen, for displaying a progress indicating unit having a plurality of progress units;
a timer, for issuing an interrupt signal according to a cycle, and any interrupt signal can issue a display instruction to accumulate at least one progress unit in said progress indicating unit;
a memory, for storing a BIOS initialization procedure and a first time value; and
a processor, for reading said first time value and the resolution of said screen to compute a display frequency for sequentially displaying said progress units on said progress indicating unit and sequentially displaying said progress units on said screen according to said display frequency.

11. The apparatus of claim 10, wherein said memory stores a second time value as a default, and said second time value will substitute said first time value if said first time value cannot be read.

12. The apparatus of claim 11, wherein said progress indicating unit is a progress bar.

13. The apparatus of claim 12, wherein said progress unit is a graphic block.

14. The apparatus of claim 13, wherein said graphic block is a block.

15. The apparatus of claim 13, wherein said graphic block is a symbol.

16. The apparatus of claim 13, wherein said graphic block is a figure.
